(19) United States
(12) Patent Application Publication
(10) Pub. No.: US 2012/0011460 A1
(43) Pub. Date: Jan. 12, 2012

(54) SYSTEM CAPABLE OF SIMULATING VARIETY OF OUTPUT/INPUT DEVICES

(75) Inventor: Ching-Wei Cheng, Keelung (TW)

(73) Assignee: ACTION STAR ENTERPRISE CO., LTD., Sijhih (TW)

(21) Appl. No.: 12/834,882

(22) Filed: Jul. 12, 2010

(51) Int. Cl. G06F 3/048

(52) U.S. Cl. 715/771

(57) ABSTRACT

The present invention relates to a system capable of simulating variety of output/input devices and connecting to at least one host, at least one display and a plurality of output/input devices, the system comprises: a control unit, a process unit, a plurality of connecting ports, a display input unit, an on-screen display (OSD) unit, and a display output unit, wherein a simulated output/input device is shown on the display after pressing a composed keystroke on the output/input device, then users can simultaneously operate the output/input device and the simulated output/input device do not need to switch the output/input device and the simulated output/input device in advance.

### BACKGROUND OF THE INVENTION

1. Technical Field

The present invention relates to a system capable of simulating an output/input device, and more particularly, to a system capable of simulating variety of output/input devices, through the system, a real output/input device and a simulated output/input device can be used at the same time.

2. Description of Related Art

With the development of the information technology, computer systems are extensively applied, and more particularly, in the application of an industrial computer system, where one host is usually connected to multi keyboards, mice and displays. Accordingly, for facilitating users input data into the host through the keyboards and the mice in the industrial computer system, computer vender proposed a switching system of a keyboard and a mouse.

Referring to FIG. 1, which illustrates a framework view of the conventional switching system of the keyboard and the mouse, as shown in FIG. 1, the switching system 1′ includes: a host 10′, a switch 12′, a real keyboard/mouse assembly 14′, and a simulated keyboard/mouse assembly 16′, wherein the host 10′ is connected to the switch 12′, and the real keyboard/mouse assembly 14′ is also connected to the switch 12′. When using the switching system 1′, the real keyboard/mouse assembly 14′ and the simulated keyboard/mouse assembly 16′ can be manually switched via the switch 12′, so that the host 10′ is able to communicate with the real keyboard/mouse assembly 14′ or the simulated keyboard/mouse assembly 16′.

In the above-mentioned switching system 1′, the real keyboard/mouse assembly 14′ and the simulated keyboard/mouse assembly 16′ are switched by way of manual operation. It is well known that manual operation could bring about the inconvenience when using the switching system 1′. Moreover, due to the transmission interface of the keyboards and the mice is a bi-directional transmission interface, so that, it must keep the host 10′ communicating with the real keyboard/mouse assembly 14′ when switching to the simulated keyboard/mouse assembly 16′. Besides, the switching system 1′ do not include a microprocessor or a controller for processing the transmitted data of the host 10′, the real keyboard/mouse assembly 14′ and the simulated keyboard/mouse assembly 16′, therefore, the real keyboard/mouse assembly 14′ can not transmit data into or receive data from the host 10′ when the host 10′ communicates with the simulated keyboard/mouse assembly 16′.

Accordingly, in view of the drawbacks and shortcomings of the conventional switching system of the keyboard and the mouse, the inventor of the present application has made great efforts to make inventive research thereon and eventually provided a system capable of simulating variety of output/input devices according to the present invention.

### BRIEF SUMMARY OF THE INVENTION

The primary objective of the present invention is to provide a system capable of simulating variety of output/input devices, through the system, a simulated output/input device is showed on a display after pressing a composed keystroke on an output/input device, and then a user are able to simultaneously operate the output/input device and the simulated output/input device do not need to switch the output/input device and the simulated output/input device in advance.

Accordingly, to achieve the abovementioned primary objective, the inventor proposes a system capable of simulating variety of output/input devices, the system is able to be connected to at least one host, at least one display and a plurality of output/input devices and comprises: a control unit, a process unit, a plurality of connecting ports, a display input unit, an on-screen display (OSD) unit, and a display output unit.

The control unit is electrically connected to the at least one host. The process unit is coupled to the control unit. The plurality of connecting ports are coupled to the process unit and capable of being connected to the plurality of output/input devices, wherein when the output/input devices are connected to the plurality of connecting ports, the process unit sends the information about the connecting ports have been connected the output/input devices.

The display input unit is connected to a display connecting port. The on-screen display (OSD) unit is coupled to the display input unit and the process unit, wherein the on-screen display unit shows a simulated output/input device on the display after pressing a composed keystroke on the output/input devices, furthermore, the simulated output/input device may be operated through the output/input devices. The display output unit is coupled to the on-screen display unit and able to be connected to the display, so as to transmit video signal to the display.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a framework view of a conventional switching system of a keyboard and a mouse;

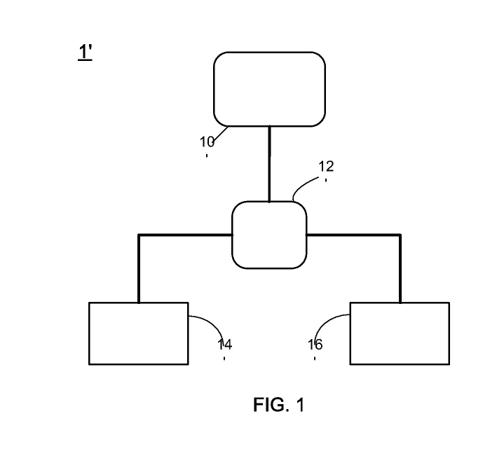

FIG. 2 is the framework view of a system capable of simulating variety of output/input devices according to the present invention;

FIG. 3 is a schematic diagram of a display;

FIG. 4 is the schematic diagram of the display and a simulated keyboard;

FIG. 5 is the schematic diagram of the display and a simulated joystick; and

FIG. 6 is a second framework view of the system capable of simulating variety of output/input devices according to the present invention.

### DETAILED DESCRIPTION OF THE INVENTION

To more clearly describe a system capable of simulating variety of output/input devices according to the present invention, an embodiment of the present invention will be described in detail with reference to the attached drawings hereinafter.

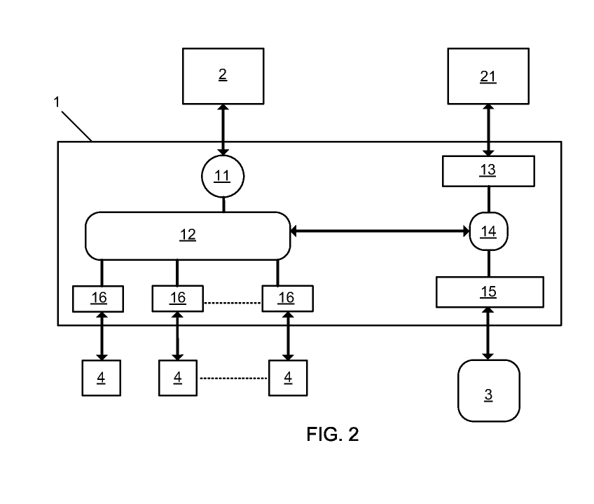

Referring to FIG. 2, which illustrates a framework view of the system capable of simulating the variety of output/input devices according to the present invention. As shown in FIG. 2, the system 1 capable of simulating variety of output/input devices is connected to a host 2, a display 3 and a plurality of output/input devices 4, including: a control unit 11, a process unit 12, a plurality of connecting ports 16, a display input unit 13, an on-screen display (OSD) unit 14, a display output unit 15.

The control unit 11 is electrically connected to the host 2. The process unit 12 is coupled to the control unit 11. The plurality of connecting ports 16 are coupled to the process unit 12 and capable of being connected to the plurality of output/input devices 4, wherein when the output/input devices 4 are connected to the plurality of connecting ports 16, the process unit 12 sends the information about the connecting ports 16 have been connected the output/input devices 4.

The display input unit 13 is connected to a display connecting port 21. The on-screen display (OSD) unit 14 is coupled to the display input unit 13 and the process unit 12, wherein the on-screen display unit 14 shows a simulated output/input device on the display 3 after pressing a composed keystroke on the output/input devices 4, and then the simulated output/input device can further be operated through the output/input devices 4. Moreover, as shown in FIG. 2, the display output unit 15 is coupled to the on-screen display unit 14 and connected to the display 3, so as to transmit video signal to the display 3.

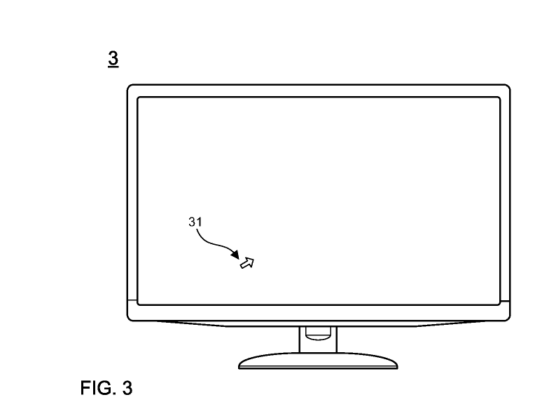

The above-mentioned output/input device 4 above is a Human Interface Device (HID) and can be a keyboard, a joystick, a touch pad, or a touch screen. Please refer to FIG. 3, which illustrates a schematic diagram of the display, wherein when the output/input device 4 connected to the connecting port 16 is the keyboard, meanwhile, after pressing the composed keystroke on the keyboard, for example, pressing a “Ctrl” keystroke, a “Alt” keystroke and a “M” keystroke at the same time, then a user is able to control a cursor 31 on the display 3 to move by means of the keystrokes of “up”, “down”, “left”, and “right” in the keyboard.

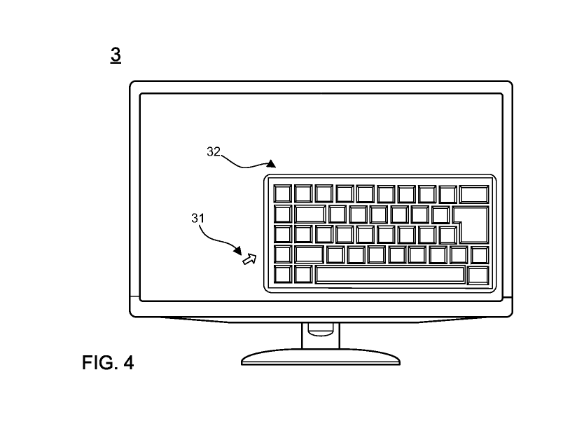

Continuously referring to FIG. 4, which illustrates the schematic diagram of the display and a simulated keyboard, wherein when the output/input device 4 connected to the connecting port 16 is the mouse, in the meantime, after pressing the composed keystroke on the mouse, for instance, simultaneously pressing the left keystroke, the right keystroke and the middle keystroke of the mouse, so that, as shown in FIG.4, a simulated keyboard 32 is shown on the display 3 by the on-screen display unit 14, and then the user can points and clicks the keystrokes of the simulated keyboard 32 by moving the cursor 32 on the display 3 via the mouse. Moreover, when the output/input device 4 connected to the connecting port 16 is two mice, meanwhile, after pressing the composed keystroke on the two mice, for example, pressing the right keystroke of one mouse and the left keystroke of another mouse at then same time, then the simulated keyboard 32 is also shown on the display 3 by the on-screen display unit 14, furthermore, the keystrokes of the simulated keyboard 32 can be pointed and clicked by means of moving the cursor 32.

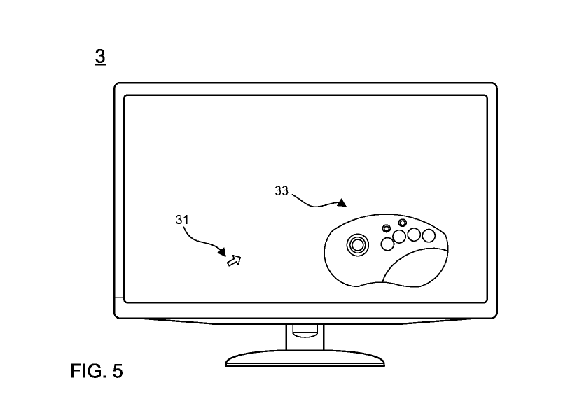

Referring to FIG. 4 and FIG. 5 together, FIG. 5 illustrates the schematic diagram of the display and a simulated joystick. Wherein when the output/input device 4 connected to the connecting port 16 is the touch pad, meanwhile, after pressing the different composed keystroke on the touch pad, the simulated keyboard 32 and a simulated joystick 33 can be respectively shown on the display 3 by the on-screen display unit 14, and then through the touch pad, the simulated keyboard 32 and the simulated joystick 33 are able to be operated. Moreover, when the output/input device 4 connected to the connecting port 16 is the touch screen, the same to the touch pad, the simulated keyboard 32 and the simulated joystick 33 are respectively shown on the display 3 by the on-screen display unit 14 after pressing the distinct composed keystroke on the touch screen. In addition, when the output/input device 4 connected to the connecting port 16 is the keyboard, the simulated joystick 33 can also be shown on the display 3 after pressing another composed keystroke in the keyboard.

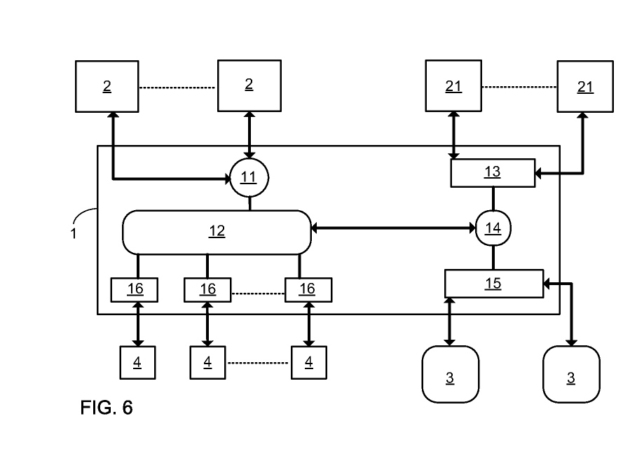

The system 1 capable of simulating the variety of output/input devices is not limited for connecting one host 2 and one display 3. Please refer to FIG. 6, which illustrates a second framework view of the system capable of simulating the variety of output/input devices according to the present invention. As shown in FIG. 6, the system 1 is connected to multi hosts 2 and displays 3, wherein through the output/input devices used by the different users, who are able to respectively call the simulated output/input devices in the different displays 3, so as to utilize the functions of the simulated output/input devices.

Thus, the system capable of simulating the variety of output/input devices according to the present invention has been disclosed completely and clearly. In summary, the present invention has the following advantages:
1. After pressing the composed keystroke on the output/input device, the simulated output/input device can be shown on the display, moreover, the user is able to simultaneously operate the output/input device and the simulated output/input device do not need to switch the output/input device and the simulated output/input device in advance.
2. The system is able to simulate the variety of output/input devices, such as the simulated cursor, the simulated keyboard and the simulated joystick.
3. The system can be connected to multi hosts and displays, therefore, through the output/input devices used by the different users, who are able to respectively call the simulated output/input devices in the different displays.
4. Inheriting the above point 3, when the system is connected to multi hosts and displays, part of hosts can only connect the mouse and do not need to connect the keyboard, moreover, another part of hosts is merely able to connect the keyboard and do not need to connect the mouse, for this reason, it is well know that the purchasing cost of the output/input devices is reduced.

The above description is made on an embodiment of the present invention. However, this embodiment is not intended to limit scope of the present invention, and all equivalent implementations or alterations within the spirit of the present invention still fall within the scope of the present invention.

I claim:

1. A system capable of simulating variety of output/input devices being connected to at least one host, at least one display and a plurality of output/input devices, the system comprising:
a control unit, being electrically connected to the at least one host;
a process unit, being coupled to the control unit;
a plurality of connecting ports, being coupled to the process unit and able to be connected to the plurality of output/input devices, when the output/input devices are connected to the plurality of connecting ports, the process unit sending the information about the connecting ports have been connected the output/input devices;
a display input unit, being connected to a display connecting port;
an on-screen display (OSD) unit, being coupled to the display input unit and the process unit, wherein the on-screen display unit shows a simulated output/input device on the display after pressing a composed keystroke on the output/input devices, furthermore, the simulated output/input device may be operated through the output/input devices; and
a display output unit, being coupled to the on-screen display unit and able to be connected to the display, so as to transmit video signal to the display.

2. The system capable of simulating variety of output/input devices of claim 1, whereon the output/input device is selected from the groups consisting of: a keyboard, a mouse, a joystick, a touch pad, a touch screen.

3. The system capable of simulating variety of output/input devices of claim 2, wherein when the output/input device connected to the connecting port is the keyboard, meanwhile, after pressing the composed keystroke on the keyboard, a cursor on the display may be controlled to move by means of the keystrokes of “up”, “down”, “left”, and “right” in the keyboard.

4. The system capable of simulating variety of output/input devices of claim 2, wherein when the output/input device connected to the connecting port is the mouse, in the meantime, a simulated keyboard being shown on the display by the on-screen display unit after pressing the composed keystroke in the mouse, and then the keystrokes of the simulated keyboard can be pointed and clicked by way of moving a cursor on the display via the mouse.

5. The system capable of simulating variety of output/input devices of claim 2, wherein when the output/input device connected to the connecting port is two mice, meanwhile, after pressing the composed keystroke in the two mice, a simulated keyboard being shown on the display by the on-screen display unit, and then the keystrokes of the simulated keyboard can be pointed and clicked by means of moving a cursor of one mouse.

6. The system capable of simulating variety of output/input devices of claim 2, wherein when the output/input device connected to the connecting port is the touch pad, in the meantime, a simulated keyboard or a simulated joystick being shown on the display by the on-screen display unit 14 after pressing the different composed keystroke in the touch pad, and then through the touch pad, the simulated keyboard and the simulated joystick may be operated.

7. The system capable of simulating variety of output/input devices of claim 2, wherein when the output/input device connected to the connecting port is the touch screen, meanwhile, after pressing the composed keystroke in the touch screen, a simulated keyboard or a simulated joystick being shown on the display by the on-screen display unit, and then the simulated keyboard and the simulated joystick are able to be operated via the touch screen.
